(19) United States
(12) Patent Application Publication
(10) Pub. No.: US 2007/0212187 A1
(43) Pub. Date: Sep. 13, 2007

(54) Anchor and method of operating the same

(76) Inventors: Martin Tervo, Dollar Bay, MI (US); Erik Kiilunen, Laurium, MI (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/371,848

(22) Filed: Mar. 9, 2006

(51) Int. Cl. F16B 13/04

(52) U.S. Cl. 411/23

(57) ABSTRACT

An anchor engageable in a structure. The anchor includes a sleeve having an outer surface, a first end, a second end, a channel extending circumferentially around the outer surface, defining an axis extending between the first and second ends, and at least partially enclosing an interior space, the outer surface defining an aperture communicating between the interior space and the channel, an adhesive supported in the interior space, and a pin supported for movement through the interior space to direct at least some of the adhesive outwardly through the aperture into the channel and axially along the outer surface of the sleeve, the pin being engageable with the first end to move the first end radially outwardly into frictional engagement with the structure.

### FIELD OF THE INVENTION

The present invention relates to anchors and, more particularly, to an anchor system for securing elements to a structure and to a method for operating the same.

### SUMMARY

In one embodiment, the invention provides an anchor engageable in a structure. The anchor can include a sleeve having an outer surface, a first end, a second end, and a channel extending circumferentially around the outer surface, defining an axis extending between the first end and the second end, and at least partially enclosing an interior space, the outer surface defining an aperture communicating between the interior space and the channel, an adhesive supported in the interior space, and a pin supported for movement through the interior space to direct at least some of the adhesive outwardly through the aperture into the channel and axially along the outer surface of the sleeve. The pin can be engageable with the first end to move the first end radially outwardly into frictional engagement with the structure. In some embodiments, the first end and the second end are engageable with the structure to prevent movement of the adhesive out of the channel and axially beyond the first end and the second end.

The present invention also provides a method of securing an element to a structure with an anchor. The anchor can include a sleeve having an outer surface, a first end, a second end, and a channel extending circumferentially around the outer surface, defining an axis extending between the first end and the second end, and at least partially enclosing an interior space. The outer surface can define an aperture communicating between the interior space and the channel. The method can include the acts of providing an adhesive supported in the interior space, inserting the sleeve into an opening in the structure, inserting a pin through the first end of the sleeve, moving the first end of the sleeve radially outwardly into frictional engagement with the structure, moving the pin through the interior space to direct at least some of the adhesive outwardly through the aperture into the channel and axially along the outer surface of the sleeve, and engaging the structure with the first end of the sleeve and the second end of the sleeve to prevent movement of the at least some of the adhesive out of the channel and axially beyond each of the first end and the second end.

In another embodiment, the invention provides an anchor engageable in a structure. The anchor can include a sleeve having an outer surface, a first end, a second end, and a channel extending circumferentially around the outer surface, defining an axis extending between the first end and the second end, and at least partially enclosing an interior space, the outer surface defining an aperture communicating between the interior space and the channel, an adhesive supported in the interior space, a pin supported in the sleeve for movement relative to the sleeve through the interior space between a retracted position, in which the pin is spaced a distance from the second end, and an extended position, in which the pin is moved toward the second end to direct at least some of the adhesive outwardly through the opening into the channel and axially along the outer surface of the sleeve, and a plurality of protrusions extending radially outwardly from the outer surface of the sleeve for engagement with the structure and being spaced along the channel. In some embodiments, the first end or the second end is radially expandable to frictionally engage the structure to prevent movement of the adhesive out of the channel and axially beyond the first end and the second end.

Other aspects of the invention will become apparent by consideration of the detailed description and accompanying drawings.

### BRIEF DESCRIPTION OF THE DRAWINGS

FIG. 1A is a cross-sectional view of an anchor system supported in a structure according to some embodiments of the present invention and including a pin supported in a first position.

FIG. 1B is an enlarged cross-sectional view of the anchor system shown in FIG. 1A.

FIG. 2A is a cross-sectional view of the anchor system shown in FIG. 1A with the pin supported in a second position.

FIG. 2B is an enlarged cross-sectional view of the anchor system shown in FIG. 2A.

FIG. 3A is a cross-sectional view of the anchor system shown in FIG. 1A with the pin supported in a third position.

FIG. 3B is an enlarged cross-sectional view of the anchor system shown in FIG. 3A.

FIG. 4 is an exploded side view of the anchor system shown in FIG. 1A.

FIG. 5 is a front perspective view of an anchor system according to an alternate embodiment of the present invention.

FIG. 6 is a rear perspective view of the anchor system shown in FIG. 5.

FIG. 7 is a front view of the anchor system shown in FIG. 5.

FIG. 8 is a side view of the anchor system shown in FIG. 5.

FIG. 9 is a front perspective view of an anchor system according to another alternate embodiment of the present invention.

FIG. 10 is a top view of the anchor system shown in FIG. 9.

FIG. 11 is a rear perspective view of the anchor system shown in FIG. 9.

FIG. 12 is a side view of the anchor system shown in FIG. 9.

FIG. 13 is a front view of the anchor system shown in FIG. 9.

FIG. 14 is a front perspective view of an anchor system according to another alternate embodiment of the present invention.

FIG. 15 is a rear perspective view of the anchor system shown in FIG. 14.

FIG. 16 is a top view of the anchor system shown in FIG. 14.

FIG. 17 is a bottom perspective view of the anchor system shown in FIG. 14.

FIG. 18 is a side view of the anchor system shown in FIG. 14.

FIG. 19 is a front view of the anchor system shown in FIG. 14.

FIG. 20 is an exploded front perspective view of the anchor system according to another alternate embodiment of the present invention.

FIG. 21 is an exploded rear perspective view of the anchor system shown in FIG. 20.

FIG. 22 is a front view of the anchor system shown in FIG. 20.

FIG. 23 is a side view of the anchor system shown in FIG. 20.

FIG. 24 is a front perspective view of an anchor system according to another alternate embodiment of the present invention.

FIG. 25 is a rear perspective view of the anchor system shown in FIG. 24.

FIG. 26 is a side view of the anchor system shown in FIG. 24.

FIG. 27 is a front view of the anchor system shown in FIG. 24.

FIG. 28 is front perspective view of an anchor system according to another alternate embodiment of the present invention.

FIG. 29 is a rear perspective view of the anchor system shown in FIG. 28.

FIG. 30 is a side view of the anchor system shown in FIG. 28.

FIG. 31 is a front view of the anchor system shown in FIG. 28.

FIG. 32 is a side view of an anchor system according to another alternate embodiment of the present invention.

FIG. 33 is a front view of the anchor system shown in FIG. 32.

FIG. 34 is a cross-sectional view taken along line 34-34.

FIG. 35 is a top view of the anchor system shown in FIG. 32.

FIG. 36 is a cross-sectional view taken along line 36-36.

FIG. 37 is a cross-sectional view taken along line 37-37.

FIG. 38 is an exploded perspective view of the anchor system shown in FIG. 32.

FIG. 39 is a perspective view of an anchor system according to another alternate embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” and “having” and variations thereof herein is meant to encompass the items listed thereafter and equivalents thereof as well as additional items.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, it is to be understood that phraseology and terminology used herein with reference to device or element orientation (such as, for example, terms like “front,” “rear,” “top,” “bottom,” “lower”, “up,” “down,” etc.) are only used to simplify description of the present invention, and do not alone indicate or imply that the device or element referred to must have a particular orientation. The elements of the present invention can be installed and operated in any orientation desired. In addition, terms such as “first”, “second,” and “third” are used herein for purposes of description and are not intended to indicate or imply relative importance or significance.

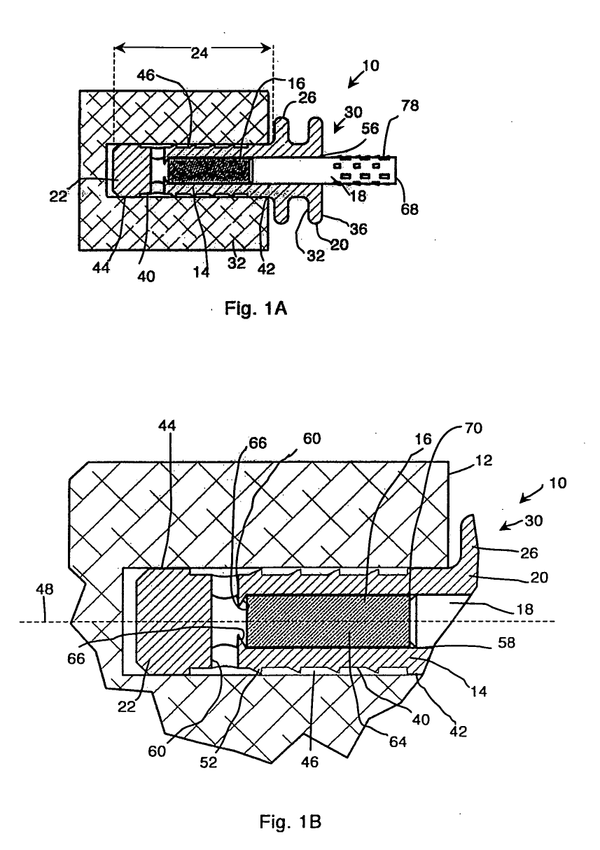

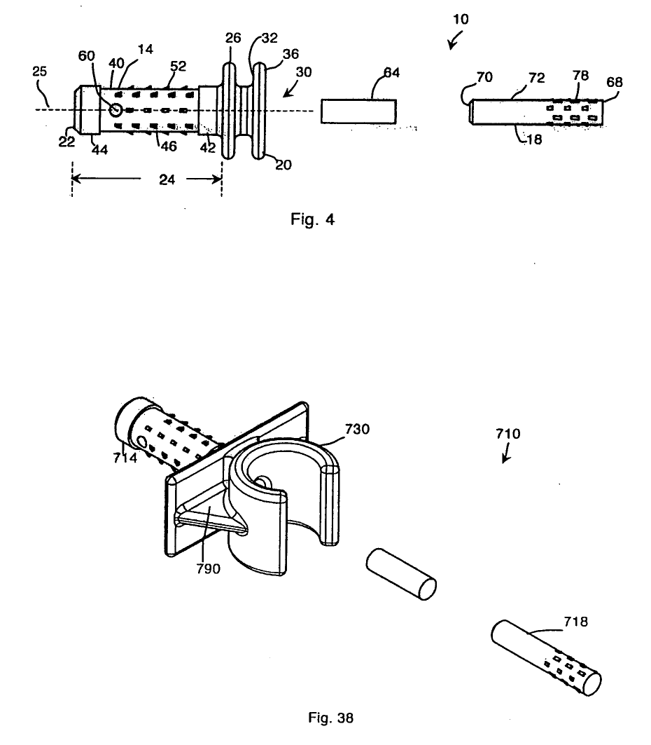

FIGS. 1A-4 illustrate an anchor system 10 for securing elements, such as, for example, shelves, pictures, clocks and other wall hangings, electrical conduit, pipes, wires, and the like to a structure 12. The anchor system 10 can be installed or used with any manmade structure 12, such as, for example, homes, commercial buildings, fences, garages, poles, frames, gutters, railings, and the like. The anchor system 10 can also be installed in caves, mines, trees, and other naturally-occurring structures 12.

The anchor system 10 can include a first anchor member or sleeve 14, an adhesive 16 supported in the sleeve 14, and a second anchor member or pin 18. In the illustrated embodiment of FIGS. 1A-4, the sleeve 14 includes a first end 20, a second end 22, and a length 24 extending between the first and second ends 20, 22. In some embodiments, the sleeve 14 defines an axis 25 extending between the first and second ends 20, 22.

In some embodiments, such as the illustrated embodiment of FIGS. 1A-4, the first end 20 includes an outwardly extending mounting flange 26. In such embodiments, the mounting flange 26 is engageable with a structure 12 to orient the anchor system 10 with respect to the structure 12. More specifically, the mounting flange 26 is engageable with the structure 12 to allow only a desired portion of the anchor system (e.g., the second end 22 of the sleeve 14) to be moved into a bore in the structure 12 and to prevent the entire anchor system 10 from falling into the bore.

The first end 20 can also include an outwardly extending fastener 30 for supporting an element on the structure 12. In the illustrated embodiment of FIGS. 1A-4, the fastener 30 has a generally circular cross-sectional shape and includes a circumferential groove 32 positioned between the mounting flange 26 and a radially outwardly extending lip 36. In this embodiment, elements, such as, for example, wires, string, twine, and the like, can be wound around the fastener 30 to secure additional elements (e.g., pictures and other wall hangings) to the structure 12. In other embodiments, other elements can slidingly and/or lockingly engage the mounting flange 26, the outwardly extending lip 36, and/or the circumferential groove 36.

The sleeve 14 also includes an outer surface 40 extending between the first end 20 and the second end 22. In the illustrated embodiment of FIGS. 1A-4, the sleeve 14 includes radially outwardly extending first and second collars 42, 44 and defines a channel 46 extending circumferentially around the outer surface 40 and extending axially along the outer surface 40 between the first and second collars 44, 46. In some embodiments, such as the illustrated embodiment of FIGS. 1A-4, the channel 46 extends axially along less than the entire length 24 of the outer surface 40 of the sleeve 14. In other embodiments, the channel 46 extends along at least about one-third of the length 24 of the outer surface 40. In still other embodiments, the channel 46 can have other relative lengths and dimensions.

The first collar 42 is engageable with the structure 12 adjacent to a proximal end of the bore in the structure 12. The second collar 44 is engageable with the structure 12 adjacent to a distal end of the bore in the structure 12 to limit movement of the sleeve 14 relative to the structure 12. In some embodiments, such as the illustrated embodiment of FIGS. 1A-4, the first and second collars 42, 44 are sized to frictionally engage an inner surface of the bore. In these embodiments, the first and second collars 42, 44 limit movement of the sleeve 14 axially through the bore and limit rotational motion of the sleeve 14 about a longitudinal axis 48 extending through the bore.

In some embodiments, such as the illustrated embodiment of FIGS. 1-4A, the first and second collars 42, 44 extend circumferentially around the outer surface 40 of the sleeve 14, and, as described in greater detail below, limit the flow of adhesive 16 axially along the outer surface 40 of the sleeve 14. In other embodiments, one or both of the first and second collars 42, 44 extend around less than the entire circumference of the outer surface 40 of the sleeve 14.

As shown in FIGS. 1A-4, in some embodiments, the sleeve 14 can also include protrusions 52 extending outwardly from the outer surface 40 between the first and second collars 42, 44 and extending outwardly into the channel 46. In these embodiments, the protrusions 42, 44 can extend radially outwardly from the outer surface 40 of the sleeve 14 to frictionally engage the inner surface of the bore in the structure 12 to limit rotational movement of the sleeve 14 about the longitudinal axis 48 of the bore and/or to limit axial movement of the sleeve 14 axially through the bore along the longitudinal axis 48.

Alternatively, in some embodiments, the protrusions 52 can extend outwardly from the outer surface 40 a distance less than the radial extent of the first collar 42 and/or the second collar 44. In these embodiments, the protrusions 52 are prevented from engaging the inner surface of the bore in the structure 12 to reduce resistance to movement of the sleeve 14 axially through the bore and/or to reduce resistance to rotational movement of the sleeve 14 in the bore.

In the illustrated embodiment of FIGS. 1A-4, the sleeve 14 also includes an opening 56 extending through the first end 20 and opening into an interior space 58 in the sleeve 14. In these embodiments, the interior space 58 can extend axially through the sleeve 14 between the first and second ends 20, 22 of the sleeve 14. In other embodiments, the interior space 58 can extend substantially less than the entire axial length 24 of the sleeve 14 and can stop short of the second end 22.

As shown in FIGS. 1A-4, apertures 60 can extend radially outwardly through the outer surface 40 of the sleeve 14 between the interior space 58 and the channel 46. In the illustrated embodiment, two apertures 60 extend outwardly through the outer surface 40 of the sleeve 14, are spaced radially around the sleeve 14 at intervals of about 180 degrees, and are positioned adjacent to the second end of the sleeve 14. In other embodiments, one, three, or more apertures 60 can extend outwardly through the outer surface 40 of the sleeve 14 and these apertures 60 can be spaced at regular or irregular intervals radially around the sleeve 14. Alternatively or in addition, the apertures 60 can be spaced adjacent to the first end 20 of the sleeve 14 or at any other position along the length 24 of the sleeve 14 to communicate with the channel 46.

The adhesive 16 can be supported in the interior 58 of the sleeve 14 adjacent to the second 22 of the sleeve 14. In some embodiments, such as the illustrated embodiment of FIGS. 1A-4, the adhesive 16 can be housed or at least partially housed in a pouch, a bag, or other storage capsule 64. In these embodiments, the sleeve 14 can include a bur or protrusion 66 extending into the interior space 58 and operable to puncture the capsule 64.

In some embodiments, the adhesive 16 can be an epoxy. In other embodiments, other adhesives, such as, for example, epoxy hybrids, resorcinol formaldehyde, phenol resorcinol formaldehyde, melamine formaldehyde, urea formaldehyde, phenolics, modified phenolics, polyaromatic high-temperature resins, polyesters, vinyl esters, polyurethanes, cyanoacrylates, modified acrylics, moisture-cure isocyantes, UV-cure cyanoacrylates, silicones, UV-cure silicones, acrylics, UV-acrylics, solvent-based thermoplastic cements, and combinations of such elements can also or alternately be used. In still other embodiments, other adhesive materials can also or alternately be used. As used herein and in the appended claims, the term “adhesive” includes cohesive and other bonding elements, and mixtures of bonding elements and cohesives.

The pin 18 includes a first end 68 and a second end 70. In the illustrated embodiment, the pin 18 has a substantially circular cross-sectional shape extending between the first and second ends 68, 70. In other embodiments, the pin 18 can have any other cross-sectional shape desired, such as, for example, square, triangular, rectangular, trapezoidal, or any other polygonal shape, oval, irregular, and the like.

In the illustrated embodiment of FIGS. 1A-4, the second end 70 of the pin 18 has a substantially smooth outer surface 72, is movable axially through the interior space 58, and is rotatable about the longitudinal axis 48 relative to the sleeve 14. As shown in FIGS. 1A-4, the first end 68 of the pin 18 can include radially outwardly extending protrusions 78 spaced along at least a portion of the first end 68 and extending radially outwardly for frictionally engaging the sleeve 14. In other embodiments, the protrusions 78 can be spaced along the entire length or substantially the entire length of the pin 18. In still other embodiments, the pin 18 can have a substantially smooth outer surface 72 extending between the first and second ends 68, 70. In these and other embodiments, the pin 18 can have a tapered and radially inwardly extending cross-sectional shape so that the first end 68 has a first cross-sectional area and the second end 70 has a second, smaller cross-sectional area.

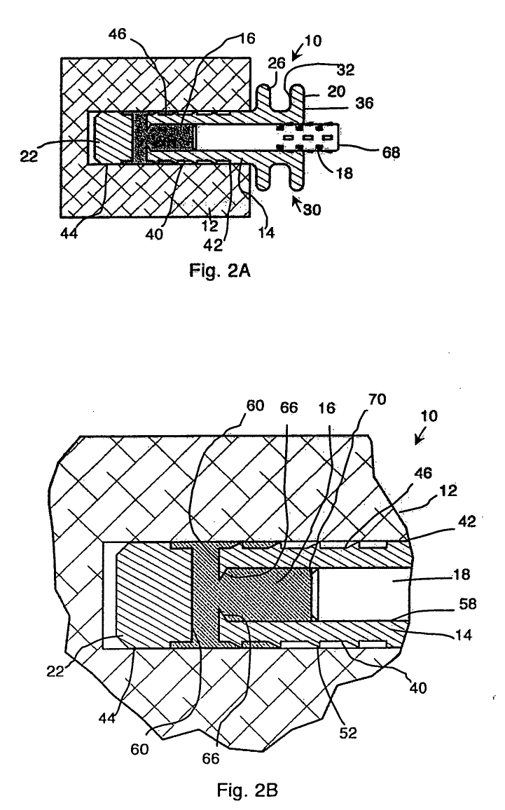

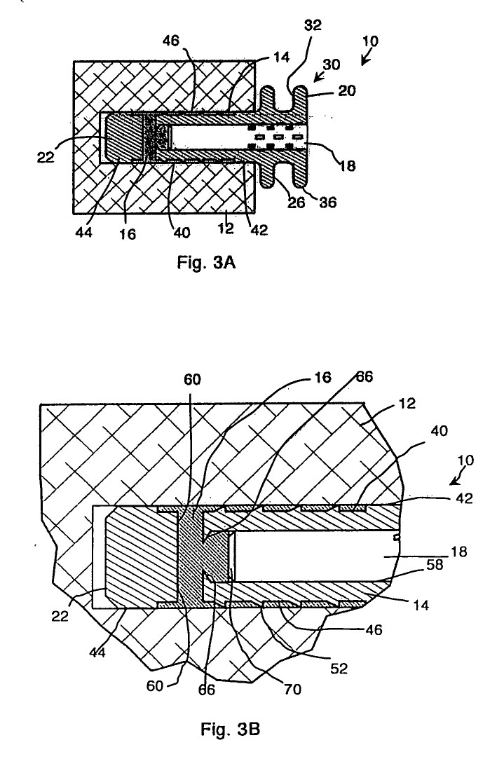

In embodiments such as the illustrated embodiment of FIGS. 1A-4 having a pin 18 with outwardly extending protrusions 78, the pin 18 can be supported in the sleeve 14 in a first position (shown in FIGS. 1A and 1B), in which the outwardly extending protrusions 78 engage the sleeve 14 and limit axial movement of the pin 18 and rotational movement of the pin 18 relative to the sleeve 14. To simplify instillation, the pin 18 can be maintained in the first position until an operator positions the anchor system 10 in a structure 12 in a desired orientation. The operator can then force the pin 18 inwardly into the interior 58 of the sleeve 14 and toward a second position (shown in FIGS. 2A and 2B), in which the pin 18 moves toward the second end 22 of the sleeve 14 forcing the adhesive 16 rearwardly toward the second end 22 of the sleeve 14 and radially outwardly through the apertures 60 into the channel 46. The operator can then continue to move the pin 18 rearwardly toward a third position (shown in FIGS. 3A and 3B), in which the first end 68 of the pin 18 is substantially inline or flush with the first end 20 of the sleeve 14, causing the adhesive 16 to substantially fill the channel 46.

In operation, an operator forms a bore in a structure 12 and inserts the sleeve 14 into the bore so that the collars 42, 44 and/or the protrusions 52 frictionally engage the structure 12, preventing the sleeve 14 from rotating about the longitudinal axis 48 relative to the structure 12 and preventing the sleeve 14 from moving axially through the bore. In embodiments having a mounting flange 26, the operator forces the sleeve 14 into the bore until the mounting flange 26 engages an outer surface of the structure 12.

The operator then inserts the pin 18 and the adhesive 16 into the interior space 58 of the sleeve 14 and forces the pin 18 rearwardly toward the second end 22 of the sleeve 14. Alternatively, in embodiments in which the pin 18 is supported in the sleeve 14 in the first position, the adhesive 16 can be pre-positioned in the interior space 58.

In the illustrated embodiment of FIGS. 1A-4, the pin 18 is driven into the sleeve 14 with a hammer. In other embodiments, other tools, including drills, screwdrivers, and the like can also or alternately be used to move the pin 18 from the first position toward the third position. In still other embodiments, an operator can move the pin 18 into the sleeve 14 without the assistance of tools.

In embodiments, such as the illustrated embodiment of FIGS. 1A-4 having an adhesive capsule 64, the pin 18 forces the adhesive capsule 64 rearwardly into engagement with the protrusion 66, which punctures the adhesive capsule 64.

As shown in FIGS. 2A and 2B, continued rearward movement of the pin 18 toward the second position, forces the adhesive 16 radially outwardly through the apertures 60 and into the channel 46. As the pin 18 is moved toward the third position (shown in FIGS. 3A and 3B), the adhesive 16 flows around the protrusions 52 located along the outer surface 40 of the sleeve 14 and substantially fills the channel 46. The adhesive 16 then bonds the sleeve 14 to the structure 12. In some embodiments, at least some of the adhesive 16 remains in the interior space 58 and bonds the pin 18 to the sleeve 14.

In addition to acting as a plunger and forcing the adhesive 16 rearwardly, in some embodiments, the pin 18 forces the sleeve 14 radially outwardly. In some such embodiments, the protrusions 78 on the outer surface 72 of the pin 18, or alternately, the tapered shape of the pin 18, cause the first end 20 and/or the second end 22 of the sleeve 14 to radially expand and to more firmly engage the inner surface of the bore in the structure 12. In these embodiments, the radial expansion of the sleeve 14 can also form a seal between the first collar 42 and the structure 12 and/or between the second collar 44 and the structure 12 to limit movement of the adhesive 16 and to prevent movement of the adhesive 16 out of the channel 46.

FIGS. 5-8 illustrate an alternate embodiment of an anchor system 110 according to the present invention. The anchor system 110 shown in FIGS. 5-8 is similar in many ways to the illustrated embodiment of FIGS. 1A-4 described above. Accordingly, with the exception of mutually inconsistent features and elements between the embodiment of FIGS. 5-8 and the embodiment of FIGS. 1A-4, reference is hereby made to the description above accompanying the embodiment of FIGS. 1A-4 for a more complete description of the features and elements (and the alternatives to the features and elements) of the embodiment of FIGS. 5-8. Features and elements in the embodiment of FIGS. 5-8 corresponding to features and elements in the embodiment of FIGS. 1A-4 are numbered in the 100 series.

As shown in FIGS. 5-8, the fastener 130 is an outwardly extending hook 182 integrally formed with the first end 120 of the sleeve 114. In other embodiments, the hook 182 can be formed separate from and be later secured to the sleeve 114.

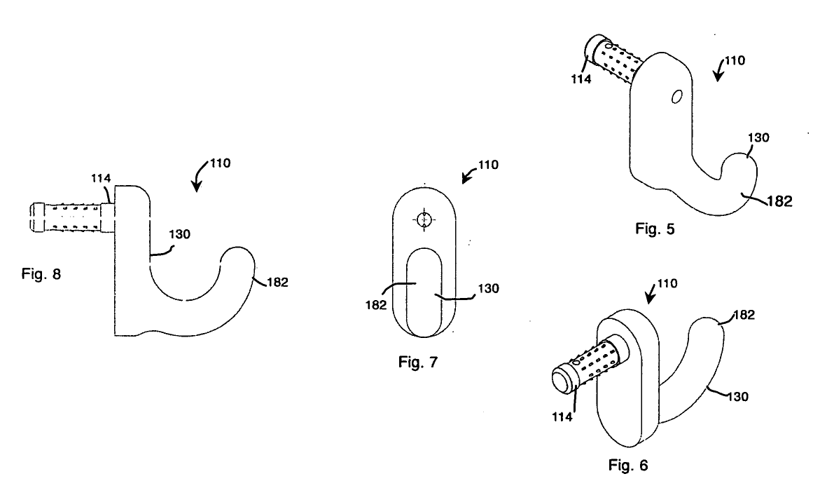

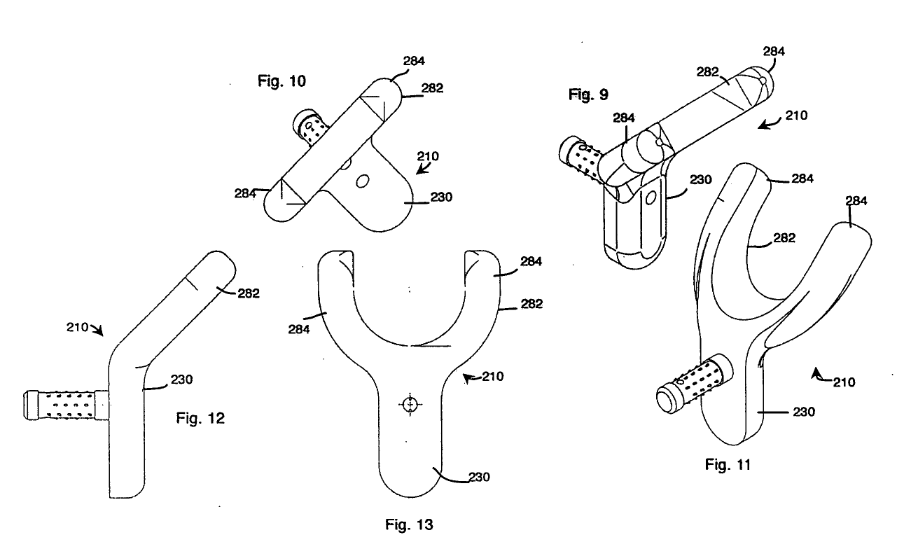

FIGS. 9-13 illustrate an alternate embodiment of an anchor system 210 according to the present invention. The anchor system 210 shown in FIGS. 9-13 is similar in many ways to the illustrated embodiments of FIGS. 1A-8 described above. Accordingly, with the exception of mutually inconsistent features and elements between the embodiment of FIGS. 9-13 and the embodiments of FIGS. 1A-8, reference is hereby made to the description above accompanying the embodiments of FIGS. 1A-8 for a more complete description of the features and elements (and the alternatives to the features and elements) of the embodiment of FIGS. 9-13. Features and elements in the embodiment of FIGS. 9-13 corresponding to features and elements in the embodiments of FIGS. 1A-8 are numbered in the 200 series.

As shown in FIGS. 9-13, the fastener 230 is an outwardly extending substantially fork-shaped hook 282 integrally formed with the first end 220 of the sleeve 214. In other embodiments, the hook 282 can be formed separate from and be later secured to the sleeve 214.

In the illustrated embodiment of FIGS. 9-13, the fork-shaped hook 282 includes two substantially similarly shaped and sized outwardly extending prongs 284. In other embodiments, the fork-shaped hook 282 can include three, four, or more outwardly extending prongs 284 having similar shapes and sizes, or alternately, having substantially different shapes and sizes.

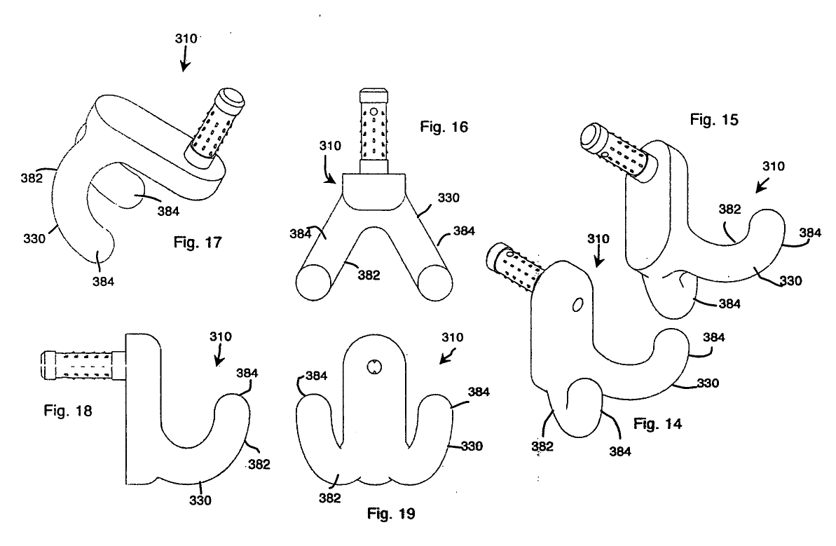

FIGS. 14-19 illustrate an alternate embodiment of an anchor system 310 according to the present invention. The anchor system 310 shown in FIGS. 14-19 is similar in many ways to the illustrated embodiments of FIGS. 1A-13 described above. Accordingly, with the exception of mutually inconsistent features and elements between the embodiment of FIGS. 14-19 and the embodiments of FIGS. 1A-13, reference is hereby made to the description above accompanying the embodiments of FIGS. 1A-13 for a more complete description of the features and elements (and the alternatives to the features and elements) of the embodiment of FIGS. 14-19. Features and elements in the embodiment of FIGS. 14-19 corresponding to features and elements in the embodiments of FIGS. 1A-13 are numbered in the 300 series.

As shown in FIGS. 14-19, the fastener 330 includes an outwardly and upwardly extending hook 382 integrally formed with the first end 320 of the sleeve 314. In other embodiments, the hook 382 can be formed separate from and be later secured to the sleeve 314.

In the illustrated embodiment of FIGS. 14-19, the fork-shaped hook 382 includes two substantially similarly shaped and sized outwardly extending prongs 384. In other embodiments, the fork-shaped hook 382 can include three, four, or more outwardly extending prongs 384 having similar shapes and sizes, or alternately, having substantially different shapes and sizes.

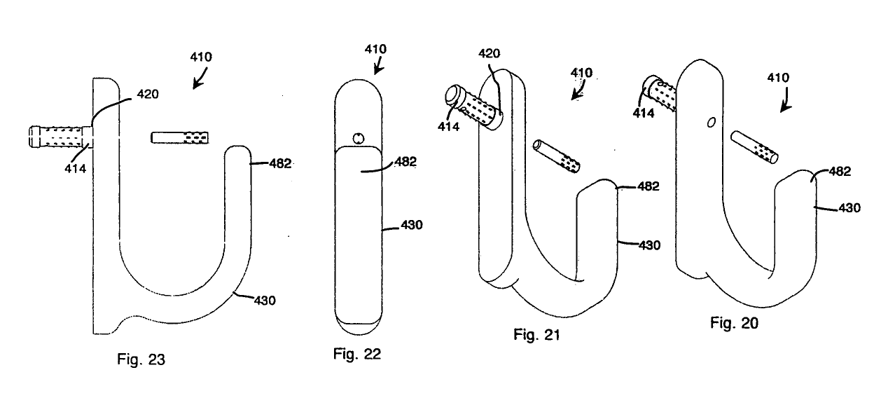

FIGS. 20-23 illustrate an alternate embodiment of an anchor system 410 according to the present invention. The anchor system 410 shown in FIGS. 20-23 is similar in many ways to the illustrated embodiments of FIGS. 1A-19 described above. Accordingly, with the exception of mutually inconsistent features and elements between the embodiment of FIGS. 20-23 and the embodiments of FIGS. 1A-19, reference is hereby made to the description above accompanying the embodiments of FIGS. 1A-19 for a more complete description of the features and elements (and the alternatives to the features and elements) of the embodiment of FIGS. 20-23. Features and elements in the embodiment of FIGS. 20-23 corresponding to features and elements in the embodiments of FIGS. 1A-19 are numbered in the 400 series.

As shown in FIGS. 20-23, the fastener 430 includes an outwardly and upwardly extending hook 482 integrally formed with the first end 420 of the sleeve 414. In other embodiments, the hook 482 can be formed separate from and be later secured to the sleeve 414.

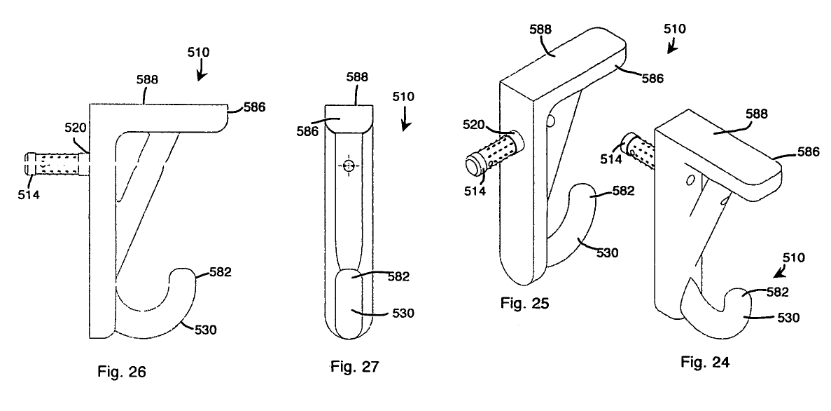

FIGS. 24-27 illustrate an alternate embodiment of an anchor system 510 according to the present invention. The anchor system 510 shown in FIGS. 24-27 is similar in many ways to the illustrated embodiments of FIGS. 1A-23 described above. Accordingly, with the exception of mutually inconsistent features and elements between the embodiment of FIGS. 24-27 and the embodiments of FIGS. 1A-23, reference is hereby made to the description above accompanying the embodiments of FIGS. 1A-23 for a more complete description of the features and elements (and the alternatives to the features and elements) of the embodiment of FIGS. 20-23. Features and elements in the embodiment of FIGS. 24-27 corresponding to features and elements in the embodiments of FIGS. 1A-23 are numbered in the 500 series.

As shown in FIGS. 24-27, the anchor system 510 includes a first fastener 530 having an outwardly and upwardly extending hook 582 integrally formed with the first end 520 of the sleeve 514 and a second fastener 586 having an outwardly extending ledge 588 for supporting shelves. In other embodiments, the hook 582 and/or the ledge 588 can be formed separate from and be later secured to the sleeve 514.

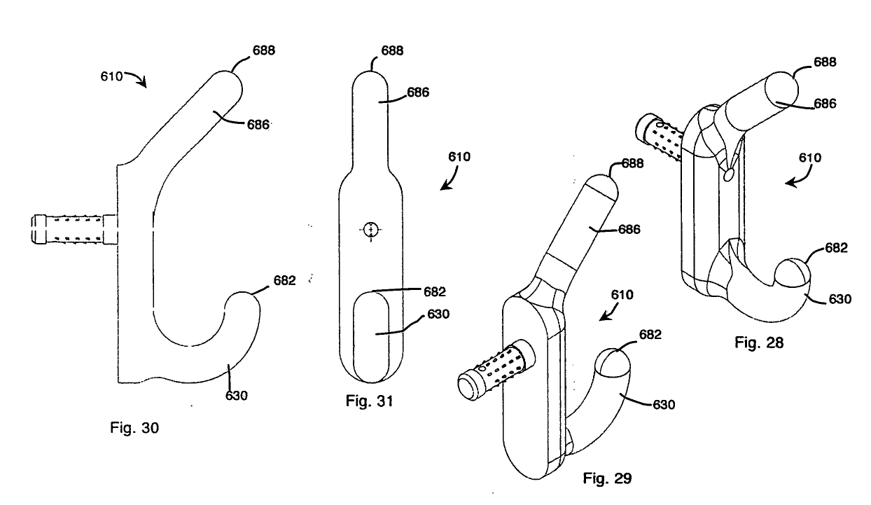

FIGS. 28-31 illustrate an alternate embodiment of an anchor system 610 according to the present invention. The anchor system 610 shown in FIGS. 28-31 is similar in many ways to the illustrated embodiments of FIGS. 1A-27 described above. Accordingly, with the exception of mutually inconsistent features and elements between the embodiment of FIGS. 28-31 and the embodiments of FIGS. 1A-27, reference is hereby made to the description above accompanying the embodiments of FIGS. 1A-27 for a more complete description of the features and elements (and the alternatives to the features and elements) of the embodiment of FIGS. 28-31. Features and elements in the embodiment of FIGS. 28-31 corresponding to features and elements in the embodiments of FIGS. 1A-27 are numbered in the 600 series.

As shown in FIGS. 28-31, the anchor system 610 includes a first fastener 630 having an outwardly and upwardly extending hook 682 and a second fastener 686 having an outwardly and upwardly extending hook 688 positioned below the hook 682 of the first fastener 630.

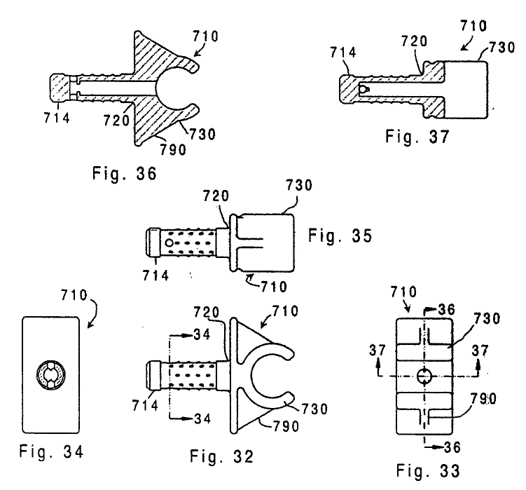

FIGS. 32-38 illustrate an alternate embodiment of an anchor system 710 according to the present invention. The anchor system 710 shown in FIGS. 32-38 is similar in many ways to the illustrated embodiments of FIGS. 1A-31 described above. Accordingly, with the exception of mutually inconsistent features and elements between the embodiment of FIGS. 32-38 and the embodiments of FIGS. 1A-31, reference is hereby made to the description above accompanying the embodiments of FIGS. 1A-31 for a more complete description of the features and elements (and the alternatives to the features and elements) of the embodiment of FIGS. 32-38. Features and elements in the embodiment of FIGS. 32-38 corresponding to features and elements in the embodiments of FIGS. 1A-31 are numbered in the 700 series.

As shown in FIGS. 32-38, the anchor system 710 includes a fastener 730 having a generally arcuate shape and webbing 790 extending between the first end 720 of the sleeve 714 and the rear end if the fastener 730. The fastener 730 is engageable with piping, conduit, and other arcuately shaped elements to support these elements in a structure 12. In some such embodiments, the sleeve 714 and/or the pin 718 can be formed of an electrically insulating material.

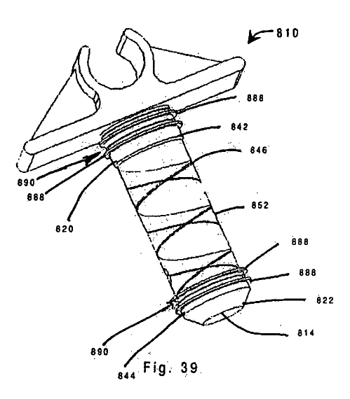

FIG. 39 illustrates an alternate embodiment of an anchor system 810 according to the present invention. The anchor system 810 shown in FIG. 39 is similar in many ways to the illustrated embodiments of FIGS. 1A-38 described above. Accordingly, with the exception of mutually inconsistent features and elements between the embodiment of FIG. 39 and the embodiments of FIGS. 1A-38, reference is hereby made to the description above accompanying the embodiments of FIGS. 1A-38 for a more complete description of the features and elements (and the alternatives to the features and elements) of the embodiment of FIG. 39. Features and elements in the embodiment of FIG. 39 corresponding to features and elements in the embodiments of FIGS. 1A-38 are numbered in the 800 series.

As shown in FIG. 39, the anchor system 810 includes a first collar 842 positioned adjacent to a first end 820 of the sleeve 814 and a second collar 844 positioned adjacent to a second end 822 of the sleeve 814. In some embodiments, such as the illustrated embodiment of FIG. 39, the first and second collars 842, 844 are deformable to at least partially engage the structure 812 and to prevent movement of adhesive axially beyond the first and second ends 820, 822 of the sleeve 814.

As shown in FIG. 39, the first and second collars 842, 844 can also include outwardly extending protrusions 888, which are deformable to at least partially engage the structure and to prevent movement of adhesive axially beyond the first and second ends 820, 822 of the sleeve 814. In the illustrated embodiment of FIG. 39, a pair of protrusions 888 extends circumferentially around each of the first and second collars 842, 844 to form a labyrinth seal 890 adjacent to the first and second ends 820, 824 of the sleeve 814.

In some embodiments, such as the illustrated embodiment of FIG. 39, the channel 846, or portions of the channel 846, extends helically around the outer surface of the sleeve 814. In these embodiments, the channel 846 can extend across or around outwardly extending protrusions 852 positioned along the outer surface of the sleeve 814.

The embodiments described above and illustrated in the figures are presented by way of example only and are not intended as a limitation upon the concepts and principles of the present invention. As such, it will be appreciated by one having ordinary skill in the art that various changes are possible. For example, various aspects of the present invention are described above as having a circular cross-sectional shape or as having elements positioned radially outwardly. It should be noted that such constructions are only presented by way of example, and are not intended to be limiting regarding cross-sectional shape of the sleeve 14, the pin 18, the adhesive 16, or the other elements of the anchor system 10.

What is claimed is:

1. An anchor engageable in a structure, the anchor comprising:
a sleeve having an outer surface, a first end, a second end, and a channel extending circumferentially around the outer surface, defining an axis extending between the first end and the second end, and at least partially enclosing an interior space, the outer surface defining an aperture communicating between the interior space and the channel;
an adhesive supported in the interior space; and
a pin supported for movement through the interior space to direct at least some of the adhesive outwardly through the aperture into the channel and axially along the outer surface of the sleeve, the pin being engageable with the first end to move the first end radially outwardly into frictional engagement with the structure to prevent movement of the at least some of the adhesive out of the channel and axially beyond the first end and the second end.

2. The anchor of claim 1, wherein the sleeve includes an inner wall at least partially defining the interior space, and wherein protrusions extend radially outwardly from one of the pin and the inner wall of the sleeve and frictionally engage an other of the pin and the inner wall of the sleeve.

3. The anchor of claim 2, wherein the protrusions support the pin in a retracted position, in which the pin is spaced a distance from the second end, and wherein the pin is movable through the interior space toward an extended position, in which the pin is moved toward the second end.

4. The anchor of claim 1, wherein the adhesive is housed in a capsule, and further comprising a protrusion extending inwardly from the sleeve into the interior space and being engageable with the capsule to puncture the capsule.

5. The anchor of claim 1, wherein the sleeve has a length measured between the first end and the second end, and wherein the channel extends less than the entire length of the sleeve.

6. The anchor of claim 1, further comprising a mounting flange extending radially outwardly from the first end of the sleeve and being engageable with the structure to orient the anchor relative to the structure.

7. The anchor of claim 1, further comprising protrusions positioned along the outer surface of the sleeve and extending radially outwardly for engagement with the structure.

8. The anchor of claim 7, wherein the protrusions extend into the channel.

9. The anchor of claim 1, wherein the sleeve has a length measured between the first end and the second end, and wherein the channel extends axially along the outer surface at least one-third of the length of the distance between the first end and the second end.

10. A method of securing an element to a structure with an anchor, the anchor including a sleeve having an outer surface, a first end, a second end, and a channel extending circumferentially around the outer surface, defining an axis extending between the first end and the second end, and at least partially enclosing an interior space, the outer surface defining an aperture communicating between the interior space and the channel, the method comprising:
providing an adhesive supported in the interior space;
inserting the sleeve into an opening in the structure;
inserting a pin through the first end of the sleeve;
moving the first end of the sleeve radially outwardly into frictional engagement with the structure;
moving the pin through the interior space to direct at least some of the adhesive outwardly through the aperture into the channel and axially along the outer surface of the sleeve; and
engaging the structure with the first end of the sleeve and the second end of the sleeve to prevent movement of the at least some of the adhesive out of the channel and axially beyond each of the first end and the second end.

11. The method of claim 10, wherein the sleeve includes an inner wall at least partially defining the interior space, wherein protrusions extend radially outwardly from the pin, and wherein the method includes frictionally engaging the inner wall of the sleeve with the protrusions.

12. The method of claim 11, wherein moving the pin through the interior space includes moving the pin from a retracted position, in which the pin is spaced a distance from the second end, toward a depressed position, in which the pin is moved toward the second end.

13. The method of claim 10, wherein a protrusion extends inwardly from the sleeve, wherein the adhesive is housed in a capsule, and wherein moving the pin through the interior space includes moving the capsule into engagement with the protrusion to puncture the capsule.

14. The method of claim 10, wherein the sleeve has a length measured between the first end and the second end, and wherein directing at least some of the adhesive outwardly through the aperture into the channel and axially along the outer surface of the sleeve includes directing the adhesive along less than the entire length of the sleeve.

15. The method of 10, wherein the sleeve includes an outwardly extending mounting flange, and wherein inserting the sleeve into the opening in the structure includes engaging the structure with the mounting flange to orient the anchor relative to the structure.

16. The method of claim 10, wherein protrusions extend radially outwardly from the sleeve, and wherein inserting the sleeve into the opening in the structure includes engaging the structure with the protrusions.

17. The method of claim 16, wherein the protrusions extend into the channel, and wherein directing at least some of the adhesive outwardly through the aperture into the channel and axially along the outer surface of the sleeve includes directing the at least some of the adhesive around the protrusions.

18. The method of claim 10, wherein the sleeve has a length measured between the first end and the second end, and wherein moving the pin through the interior space to direct at least some of the adhesive outwardly through the aperture into the channel and axially along the outer surface of the sleeve includes directing the at least some of the adhesive axially along the channel at least one-third of the length of the distance between the first end and the second end.

19. An anchor engageable in a structure, the anchor comprising:
a sleeve having an outer surface, a first end, a second end, and a channel extending circumferentially around the outer surface, defining an axis extending between the first end and the second end, and at least partially enclosing an interior space, the outer surface defining an aperture communicating between the interior space and the channel;
an adhesive supported in the interior space;
a pin supported in the sleeve for movement relative to the sleeve through the interior space between a retracted position, in which the pin is spaced a distance from the second end, and an extended position, in which the pin is moved toward the second end to direct at least some of the adhesive outwardly through the aperture into the channel and axially along the outer surface of the sleeve; and
a plurality of protrusions extending radially outwardly from the outer surface of the sleeve for engagement with the structure and being spaced along the channel;
wherein one of the first end and the second end is radially expandable to frictionally engage the structure to prevent movement of the at least some of the adhesive out of the channel and axially beyond the first end and the second end.

20. The anchor of claim 19, wherein the sleeve includes an inner wall at least partially defining the interior space, and wherein a plurality of projections extend radially outwardly from one of the pin and the inner wall of the sleeve and frictionally engage an other of the pin and the inner wall of the sleeve to maintain the pin in the retracted position.

21. The anchor of claim 19, wherein the adhesive is housed in a capsule, and further comprising a projection extending inwardly from the sleeve into the interior space and being engageable with the capsule to puncture the capsule.

22. The anchor of claim 19, wherein the sleeve has a length measured between the first end and the second end, and wherein the channel extends less than the entire length of the sleeve.

23. The anchor of claim 19, further comprising a mounting flange extending radially outwardly from the first end of the sleeve and being engageable with the structure to orient the anchor relative to the structure.
